(19) United States
(12) Patent Application Publication
(10) Pub. No.: US 2026/0235812 A1
(43) Pub. Date: Aug. 13, 2026

(54) COUPLER TO CONNECT A SOLID CORE FIBER WITH A HOLLOW CORE FIBER

(71) Applicant: Relativity Networks, Inc., Winter Park, FL (US)

(72) Inventors: Lawrence SHAH, Winter Park, FL (US); Richard James BACA, Brentwood, TN (US); Rodrigo AMEZCUA CORREA, Orlando, FL (US); Timothy BATE, Orlando, FL (US); Jose Enrique ANTONIO-LOPEZ, Orlando, FL (US); Miguel BANDRES, Oviedo, FL (US); Jason M. EICHENHOLZ, Orlando, FL (US)

(21) Appl. No.: 19/532,207

(22) Filed: Feb. 6, 2026

Related U.S. Application Data
(60) Provisional application No. 63/756,734, filed on Feb. 10, 2025.
(60) Provisional application No. 63/829,483, filed on Jun. 24, 2025.

(51) Int. Cl. G02B 6/26; G02B 6/02; G02B 6/028

(52) U.S. Cl. CPC G02B 6/268; G02B 6/0281; G02B 6/262; G02B 6/02328

(57) ABSTRACT

A coupler for connecting a single mode fiber (SMF) and a hollow core fiber (HCF) is disclosed. The coupler may include an SMF portion, an HCF portion and a graded index fiber (GRIN) portion. The GRIN portion may be disposed between the SMF portion and the HCF portion. One end of the GRIN portion may touch the SMF portion, and the other end of the GRIN portion that faces the HCF portion may be engineered to reduce back-reflection.

### CROSS-REFERENCE TO RELATED APPLICATIONS

The present application claims the benefit of U.S. Provisional Patent Application 63/756,734 filed Feb. 10, 2025 and U.S. Provisional Patent Application 63/829,483 filed Jun. 24, 2025, the entireties of which are incorporated by reference herein.

### TECHNICAL FIELD

The present disclosure relates generally to couplers or connectors to connect two optical fibers, and more specifically to a coupler to connect a solid core optical fiber with a hollow core optical fiber.

### BACKGROUND OF THE INVENTION

Increasing cloud compute, machine learning and data storage requirements are driving the construction of hyper-scale data centers at a fast rate. Existing data centers generally use solid or glass core single mode fiber (SMF) based infrastructure and equipment.

Furthermore, as the demand for telecom services, Internet, voice or video calls, information exchange, etc. has exponentially increased over the past few decades, newer telecom infrastructure is being developed that offers higher speed, enhanced bandwidth and lower latency. An example of such a telecom infrastructure includes hollow-core fibers (HCFs). An HCF offers various benefits over the traditional glass or solid core SMF including, but not limited to, a high average and peak power capability, high damage thresholds, low latency, low non-linearities, etc.

Integrating HCFs into existing SMF-based systems and infrastructure is challenging. HCFs typically have more complex design and geometry compared to conventional solid core/glass core fibers (conventional glass core SMFs) and hence pose challenges in practical implementations and field installation. For example, one challenge lies in the precise cleaving, alignment and complex splicing process required for splicing HCF to conventional glass core fibers (conventional solid core SMFs), which complicates the deployment of HCF cables. Splicing HCF cables require specialized equipment, specialized personnel, and increases the installation time relative to the cables with conventional SMF.

Another challenge is the connection or insertion loss in signal transmission between the SMF and the HCF due to mode field size mismatch between the HCF and the SMF. Furthermore, it is known that back reflection in signal transmission occurs when optical signals travel from the solid core of an SMF to a hollow core of an HCF, or vice-versa. This back reflection may lead to signal loss and multipath interference, and is hence undesirable.

Therefore, it is desirable to facilitate efficient connection of HCFs to existing SMF-based systems, while making the installation process easy and convenient for the field operators.

### BRIEF DESCRIPTION OF THE DRAWINGS

Various embodiments of the invention are disclosed in the following detailed description and the accompanying drawings.

FIG. 1 depicts a schematic diagram of a first example coupler to connect a single mode fiber (SMF) with a hollow core fiber (HCF) in accordance with one or more embodiments of the present disclosure.

FIG. 2 depicts a schematic diagram of a second example coupler to connect an SMF with an HCF in accordance with one or more embodiments of the present disclosure.

FIG. 3 depicts a schematic diagram of a third example coupler to connect an SMF with an HCF in accordance with one or more embodiments of the present disclosure.

FIG. 4 depicts a schematic diagram of a fourth example coupler to connect an SMF with an HCF in accordance with one or more embodiments of the present disclosure.

FIG. 5 depicts a schematic diagram of a fifth example coupler to connect an SMF with an HCF in accordance with one or more embodiments of the present disclosure.

FIG. 6 depicts a schematic diagram of a sixth example coupler to connect an SMF with an HCF in accordance with one or more embodiments of the present disclosure.

FIG. 7 depicts a schematic diagram of a seventh example coupler to connect an SMF with an HCF in accordance with one or more embodiments of the present disclosure.

FIG. 8 depicts a schematic diagram of an eighth example coupler to connect an SMF with an HCF in accordance with one or more embodiments of the present disclosure.

FIG. 9 depicts a schematic diagram of a ninth example coupler to connect an HCF with an HCF in accordance with one or more embodiments of the present disclosure.

FIG. 10 depicts a schematic diagram of a tenth example coupler to connect an SMF with an HCF in accordance with one or more embodiments of the present disclosure.

FIG. 11 depicts a schematic diagram of an eleventh example coupler to connect an SMF with an HCF in accordance with one or more embodiments of the present disclosure.

FIG. 12 depicts an example graph between a mode field diameter (MFD) of an SMF and a length of a Graded Index Fiber (GRIN) in accordance with one or more embodiments of the present disclosure.

FIG. 13 is a flow diagram of a first example method to make a coupler to connect an SMF with an HCF in accordance with one or more embodiments of the present disclosure.

FIG. 14 is a flow diagram of a second example method to make a coupler to connect an SMF with an HCF in accordance with one or more embodiments of the present disclosure.

FIG. 15 is a flow diagram of a third example method to make a coupler to connect an SMF with an HCF in accordance with one or more embodiments of the present disclosure.

### SUMMARY

A coupler to connect a single mode fiber (SMF) and a hollow core fiber (HCF) is disclosed in accordance with one or more illustrative embodiments. In some embodiments, the coupler may include an SMF portion and an HCF portion. The coupler may further include a graded index fiber (GRIN) portion disposed between the SMF portion and the HCF portion. The GRIN portion may include a GRIN proximal end and a GRIN distal end. The GRIN proximal end may touch the SMF portion, and the GRIN distal end may be engineered to reduce back-reflection.

In some embodiments, the GRIN distal end may be engineered by etching a parabolic divot or a negative lens at the GRIN distal end. A profile or curvature of the parabolic divot may be based on a doping profile of the GRIN portion. The GRIN portion may have a parabolic doping profile or distribution in which a dopant concentration is highest at a center portion of a cross-section of the GRIN portion. In certain embodiments, the doping profile of the GRIN portion may itself be engineered or adjusted so that the profile or curvature of the parabolic divot matches with an optimal curvature that focuses optical signals output from the SMF portion to a hollow core of the HCF portion.

In certain embodiments, the GRIN distal end may touch the HCF portion. Specifically, the GRIN distal end may be attached to the HCF portion by fusion splicing or by using an adhesive.

In other embodiments, the GRIN distal end may be engineered by applying an anti-reflection (AR) coating to the GRIN distal end or by applying a dielectric coating to the GRIN distal end and then processing the dielectric coating to produce an etched or textured surface. In this case, a gap of a predefined non-zero length may be present between the GRIN distal end and the HCF portion. The gap may be filled with air or a predetermined gas. Furthermore, in this case, the coupler may additionally include a mechanical enclosure, which may enclose the GRIN portion, the gap, and predefined parts or lengths of the SMF portion and the HCF portion.

In accordance with further embodiments of the present disclosure, a coupler having an SMF portion, an HCF portion, a GRIN portion and a secondary fiber portion is disclosed. The GRIN portion may include a GRIN proximal end and a GRIN distal end. The GRIN proximal end may touch the SMF portion. Further, the secondary fiber portion may have a secondary fiber proximal end and a secondary fiber distal end. The secondary fiber proximal end may be attached to the GRIN distal end by fusion splicing or by using an adhesive, and the secondary fiber distal end may be engineered to reduce back-reflection.

In some embodiments, the secondary fiber portion may be a low numerical aperture (NA) fiber portion. In other embodiments, the secondary fiber portion may be a coreless fiber portion.

In certain embodiments, the secondary fiber distal end may be engineered by applying an anti-reflection (AR) coating to the secondary fiber distal end. In other embodiments, the secondary fiber distal end may be engineered by etching the secondary fiber distal end using a motheye etching process. In some embodiments, the distal end may be an angled surface treated with a motheye etching process or with an AR coating applied.

In some embodiments, the secondary fiber distal end may be attached to the HCF portion by fusion splicing or by using an adhesive. In other embodiments, a gap of a predefined non-zero length may be present between the secondary fiber distal end and the HCF portion.

The coupler may additionally include a mechanical enclosure, which may enclose the GRIN portion, the secondary fiber portion, the gap, and predefined parts or lengths of the SMF portion and the HCF portion.

In accordance with further embodiments of the present disclosure, a coupler having an SMF portion, an HCF portion and a metasurface is disclosed. The SMF portion may include an SMF proximal end and an SMF distal end. The SMF distal end may face the HCF portion, and the metasurface may be added to the SMF distal end.

In certain embodiments, a gap of a predefined non-zero length may be present between the metasurface and the HCF portion. The coupler may additionally include a mechanical enclosure, which may enclose the metasurface, the gap, and predefined parts or lengths of the SMF portion and the HCF portion.

In accordance with further embodiments of the present disclosure, a coupler having an SMF portion, an HCF portion and a lens is disclosed. The SMF portion may include an SMF proximal end and an SMF distal end. The SMF distal end may face the HCF portion, and the lens may be added to the SMF distal end.

In certain embodiments, a gap of a predefined non-zero length may be present between the lens and the HCF portion. The coupler may additionally include a mechanical enclosure, which may enclose the lens, the gap, and predefined parts or lengths of the SMF portion and the HCF portion.

In accordance with further embodiments of the present disclosure, a coupler having an SMF portion and an HCF portion is disclosed. A central axis of the SMF portion may be disposed at a non-zero offset from a central axis of the HCF portion. The coupler may further include one or more reflective surfaces that may enable an optical signal output from the SMF portion to enter the HCF portion or enable an optical signal output from the HCF portion to enter the SMF portion.

In accordance with yet another embodiment of the present disclosure, a coupler for coupling an HCF with another HCF is disclosed. The coupler may include an HCF portion having an HCF proximal end and an HCF distal end. A lens or metasurface may be added to the HCF proximal end.

### DETAILED DESCRIPTION

The invention can be implemented in numerous ways, including as a process; an apparatus; a system; a combination of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure are directed to a coupler to connect a standard solid/glass core fiber/single mode fiber (SMF) with a hollow core fiber (HCF). The coupler, as described in the present disclosure, makes the integration or connection process of an SMF with an HCF easy and fast to implement in the field. The coupler enables a robust connection between an SMF and an HCF, which minimizes insertion or connection loss and back reflection in optical signal transmission between the SMF and the HCF, as described in the description below.

It is known that an HCF includes a hollow core and one or more anti-resonant elements. In the anti-resonant HCFs, light or optical signal is guided in the hollow core as a result of anti-resonant properties of thin walled structures extending along the length of the fiber. Since the light or optical signal is guided in a “hollow” core in an HCF, as opposed to a solid/glass core in the case of a standard solid/glass core fiber, the speed of travel of an optical signal (and hence the speed of signal transmission) in an HCF is considerably greater than the speed of signal transmission in a solid/glass core optical fiber. Specifically, since the optical signal travels through the hollow core in an HCF, which is essentially vacuum having an index of refraction (“n”) as 1, the optical signal travels through the HCF at a speed that is equivalent to (or substantially equivalent to) the speed of light (as speed of signal in the medium=speed of light (“c”)/n). This is in contrast to the speed of an optical signal in a solid/glass core fiber, which typically has an index of refraction in a range of 1.4-1.5, and hence offers a lower speed of signal transmission.

Furthermore, HCFs offer various benefits over standard solid/glass core fibers including, but not limited to, high average and peak power capability, high damage thresholds, low latency, low non-linearities, etc. Considering these advantages and the greater speed of signal transmission, many telecom service providers are adopting HCFs for signal transmission, to provide enhanced services to their customers. For example, many service providers are deploying HCF cables (that include the HCFs) for data center interconnect networks. In this case, the HCF is used to connect two data centers with low latency and high bandwidth. The data centers may be located far away from each other (e.g., in two separate buildings within a campus, or in two different cities, states, etc.), or may be located close to each other (e.g., within the same building). A “data center”, as described in the present disclosure, may refer to or may include any type of processor or processing unit (e.g., a Central Processing Unit (CPU), Graphics Processing Unit (GPU), and/or the like). For example, a data center may refer to a building or facility that includes multiple processors as well as servers, storage, or networking equipment.

It is known that existing data centers generally use SMF based infrastructure. Therefore, when an HCF cable is deployed for a data center interconnect network, the HCF cable is typically installed outside the data center building inside conduits, which enter the building into the data center optical cable entry facility. At this location, the HCF cable is typically spliced or coupled with indoor conventional solid/glass core fiber cables (or SMF cables). The splice of an HCF to a conventional SMF is a time consuming and challenging process that requires special equipment and personnel. If not done properly, the splice or the coupling point may become a point of failure and may result in considerable signal loss. It may be appreciated that signal or insertion loss may occur at the connection interface between the HCF and the SMF due to mode field size mismatch between the HCF and the SMF. Furthermore, back reflection at the connection interface may occur when optical signals travel from the solid core of the SMF to the hollow core of the HCF, or vice-versa. This back reflection may lead to signal loss and multipath interference, and is hence undesirable.

To mitigate the challenges described above and to make the HCF-SMF integration/connection process simpler for the field operators, the present disclosure proposes a coupler that includes an SMF portion (or an SMF pigtail) at one end and an HCF portion (or an HCF pigtail) at a second end. An operator may conveniently splice or mechanically connect the SMF portion/pigtail to the data center's SMF, and splice or mechanically connect the HCF portion/pigtail to the HCF cable. In this manner, the operator is not required to splice the data center's SMF with the HCF, but may only be required to splice or connect the data center's SMF with the SMF portion/pigtail and the HCF cable with the HCF portion/pigtail. It is known that SMF-to-SMF and HCF-to-HCF splicing/connection process is relatively simpler than SMF-to-HCF splicing/connection process. By using the coupler disclosed in the present disclosure, the operator is not required to perform the SMF-HCF splicing or connection process in the field, and hence the connection process of the HCF cable with the data center's SMF becomes simpler and less time-consuming.

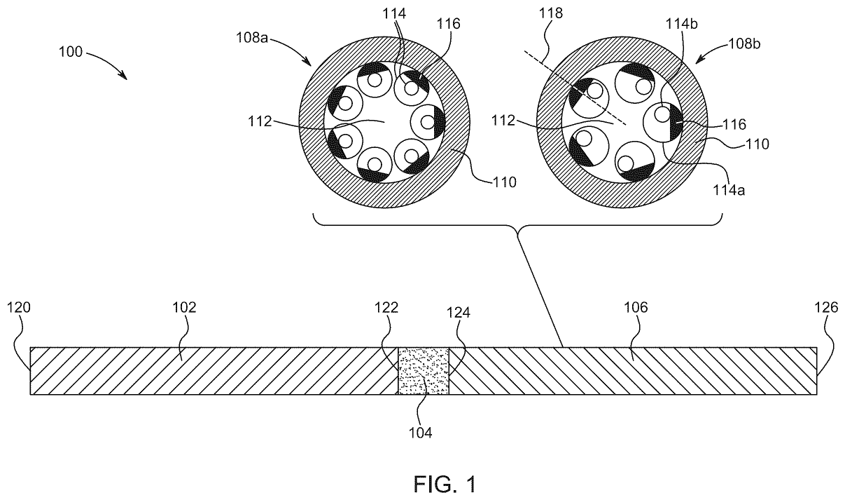

The present disclosure proposes multiple designs of a coupler that facilities the operator to conveniently connect an SMF with an HCF. In accordance with further embodiments of the present disclosure, the present disclosure also proposes a design of a coupler that enables robust connection of an HCF to another HCF. The details of the coupler designs are briefly described below and described in detail later in conjunction with FIGS. 1-11.

In one exemplary embodiment, a first coupler is disclosed that may include an SMF portion (or an SMF pigtail), an HCF portion (or an HCF pigtail), and a graded index fiber (GIF or GRIN) portion or a multi-mode fiber (MMF) portion. The GIF/GRIN/MMF portion is referred to as GRIN portion in the present disclosure. In the first coupler, the GRIN portion is disposed between the SMF portion and the HCF portion, and touches/abuts both the SMF portion and the HCF portion. Specifically, in the first coupler, the opposite ends of the GRIN portion are attached (e.g., fusion spliced at the factory or bonded together at the factory using an adhesive) to the proximal and distal ends of the HCF and SMF portions respectively that face the GRIN portion. The other ends of the SMF and HCF portions that face away from the GRIN portion may be used by the operator to splice/connect with the data center's SMF and the HCF cable. In an exemplary embodiment, the SMF portion and the HCF portion may have lengths of approximately 1-3 meters each, and the GRIN portion may have a length in the range of 260-300 micrometers. Further, in some embodiments, the SMF-GRIN-HCF spliced/bonded section may be protected by a splice protector (which may be a mechanical structure that protects the SMF-GRIN-HCF spliced/bonded section from ambient environment).

The end surfaces of two fiber-optic components (which include a SMF portion, HCF portion, GRIN portion, and secondary fiber portion) may be attached together by fusion splicing or by using an adhesive. Fusion splicing may be performed by a fiber-optic fusion splicer that may include one or more cameras that image the fiber-optic components and one or more mechanical positioners that position or rotate the components prior to performing the fusion-splicing operation. Attaching the end surfaces of two fiber-optic components using adhesive may be referred to as bonding the components together. An adhesive used to bond fiber-optic components together may refer to any suitable adhesive or epoxy. For example, an adhesive for attaching fiber-optic components may include optically clear adhesive, optically clear epoxy, UV-curable adhesive, optically clear silicone, index-matched adhesive, or index-matching gel.

It is known that in a GRIN fiber, the refractive index of the core gradually decreases from the center to the outer edge rather than having a uniform value. Specifically, the GRIN fiber has a parabolic doping profile or distribution in which a dopant concentration is highest at a center portion of a cross-section of the GRIN fiber, and the dopant concentration gradually decreases towards the outer edge of the GRIN fiber. Typically, germanium (Ge) is used as a dopant in the GRIN fiber, but in certain cases, fluorine may also be used as the dopant. The refractive index of the GRIN fiber is proportional to its dopant concentration. Therefore, the refractive index of the GRIN fiber is highest at the center portion of the GRIN fiber, and gradually decreases towards the outer edge of the GRIN fiber. This is in contrast to an SMF fiber, in which the refractive index changes abruptly from the core to the cladding layer. The GRIN fiber typically has a larger core diameter and mode field diameter (MFD) as compared to the SMF fiber. Further, the HCF fiber also has a larger MFD as compared to the SMF fiber. Therefore, if the SMF is directly connected or spliced with the HCF, mode field size mismatch may occur, which may result in connection or insertion loss. To mitigate this effect, the GRIN portion is spliced or bonded to the SMF portion, and disposed between the SMF portion and the HCF portion to reduce the mode field size mismatch.

The GRIN portion expands or reshapes the optical mode of the SMF to better match the mode profile of the HCF, thereby reducing connection losses and minimizing back reflection. Furthermore, the GRIN portion collimates or focuses the optical signal/beam output from the SMF before it enters the HCF, thereby minimizing diffraction and insertion loss. Herein, focusing an optical signal/beam refers to producing a converging beam with transverse dimensions that decrease as the beam propagates or producing a diverging or expanding beam with dimensions that increase as the beam propagates. In this manner, the GRIN portion in the first coupler acts as a beam-shaping and mode-matching element (or as a mode field adaptor, “MFA”) between the SMF portion and the HCF portion, which reduces insertion loss and back reflection of optical signals at the SMF-HCF interface.

It may be appreciated that GRIN-to-HCF fusion splicing or bonding may be a challenging and difficult process. To make the coupler manufacturing process simpler and to improve the coupler performance by further reducing the signal back reflection, the present disclosure proposes a design of a second coupler in which the end of the GRIN portion that faces the HCF portion may be “engineered” by coating it with an anti-reflection (AR) coating to reduce back reflection. Further, in the second coupler, the end of the GRIN portion that is coated with the AR coating is not spliced or bonded with the HCF portion.

In certain embodiments, in the second coupler, one end of the GRIN portion may be spliced or bonded with the SMF portion (e.g., to reduce mode field size mismatch between the SMF and the HCF) and the other end of the GRIN portion may be disposed a predefined distance away from the HCF portion so that a gap may exist between the GRIN portion and the HCF portion. The gap may be filled with air or a predefined gas, and may have a length in a range of 10 micrometers to 1 millimeter. As described above, the end of the GRIN portion that faces the HCF portion (or the air gap) may be coated with the AR coating, which may be, for example, a dielectric coating.

In some aspects, the air gap may cause some small amount of connection loss in the second coupler, but the gain in terms of reducing the back reflection is substantial (due to the AR coating at the GRIN surface that faces the HCF portion). For example, in the first coupler, the back reflection is approximately-20 dB; and in the second coupler, the back reflection is less than −40 dB.

As may be appreciated, fusion splicing a surface coated with an AR coating (e.g., the GRIN surface that faces the HCF portion in the second coupler) may adversely affect the AR coating layer. Therefore, in the second coupler, the GRIN surface that is coated with the AR coating (and that faces the HCF portion) is not fusion spliced with the HCF portion, but is rather kept a predefined distance away from the HCF portion so that the air gap described above may be maintained. Since fusion splicing of the GRIN surface with the HCF portion is not performed in the second coupler, the second coupler may be relatively easier to manufacture as compared to the first coupler.

To ensure that such an arrangement of the SMF-GRIN-Air Gap-HCF is secure in the second coupler, the second coupler may further include a mechanical structure or enclosure that may robustly secure this entire arrangement. The mechanical enclosure may be sealed, so that air or any foreign particle may not enter the SMF-GRIN-Air Gap-HCF interface. The mechanical enclosure may further ensure optimal alignment between the SMF portion, the GRIN portion and the HCF portion, to further enhance the coupler's optical signal transmission properties and to reduce connection losses. In certain embodiments, the second coupler may additionally include or incorporate an alignment groove to optimally align the SMF portion, the GRIN portion and the HCF portion. The alignment groove may be made by using a Silicon Optical Bench (SiOB) or CMOS lithographic process, or any other suitable known process.

In accordance with further embodiments of the present disclosure, a design of a third coupler is disclosed in which the end of the GRIN portion that faces the HCF portion may be “engineered” by etching a parabolic divot or a negative lens. A profile or curvature of the parabolic divot/negative lens may be based on the doping profile of the GRIN portion. Specifically, as described above, the GRIN portion has a parabolic doping profile or distribution in which the dopant concentration is highest at the center portion of the cross-section of the GRIN portion, and the dopant concentration gradually decreases towards the outer edge of the GRIN portion. Therefore, the etching is more pronounced at the center portion of the GRIN portion. Consequently, the curvature of the divot or the negative lens is highest at the center portion of the GRIN portion and gradually decreases towards the outer edge of the GRIN portion.

In some aspects, the parabolic divot/negative lens may collimate or focus the light or the optical signal traveling from the SMF to the HCF, as opposed to causing the light to reflect back into the SMF at the glass-air interface (i.e., at the GRIN-HCF interface). It may be appreciated that if the end of the GRIN portion that faces the HCF portion is flat or straight (i.e., the end surface is non-angled or has a “zero-degree” interface), considerable light traveling from the SMF to the HCF may back-reflect at the glass-air interface. To avoid such a scenario, the parabolic divot/negative lens is provided that may collimate or focus the light, but may not allow the light to back-reflect into the SMF.

In additional embodiments, the present disclosure proposes to engineer/adjust/modify the doping profile of the GRIN portion based on the curvature of the divot or the negative lens that is required. Stated another way, the doping profile or the distribution of the dopant (e.g., Ge or fluorine) in the GRIN portion may be engineered so that the profile or curvature of the parabolic divot/negative lens matches with an optimal curvature that enables optical signals output from the SMF portion to be focused on the hollow core of the HCF portion. It may be appreciated that if the dopant profile of the GRIN portion is modified, then the etching profile of the end of the GRIN portion that faces the HCF portion would also be modified (and it may or may not remain a parabolic-shaped surface). The dopant profile of the GRIN portion may be engineered based on the etching profile of the divot that is required or is expected to provide the best performance (in terms of reducing back reflection, scattering and distortion of signals at the GRIN-HCF interface), and then the GRIN portion surface can be etched accordingly. By engineering the dopant profile of the GRIN portion (and hence the etching profile of the GRIN portion surface that faces the HCF portion), the SMF-to-HCF interface may be optimally lensed. In this manner, the dopant profile of the GRIN portion may be engineered based on the lensing effect or the curvature of the parabolic divot/lens that is required to provide the best optical performance and low or no back-reflection at the GRIN-HCF interface.

In certain embodiments, in the third coupler, the end of the GRIN portion containing the parabolic divot/negative lens may be attached to the HCF portion by fusion splicing or by using an adhesive. In further embodiments, a design of a fourth coupler is disclosed in which the end of the GRIN portion containing the parabolic divot/negative lens is kept a predefined distance away from the HCF portion so that a gap may exist between the GRIN portion and the HCF portion. In this case, the fourth coupler may additionally include the mechanical enclosure described above that may enclose the GRIN portion (containing the parabolic divot), the gap, and predefined parts or lengths of the SMF portion and the HCF portion.

In accordance with further embodiments of the present disclosure, a design of a fifth coupler is disclosed in which the MFA surface that faces the HCF portion is etched using a motheye etching process. It is known that by adding a metasurface to an optical fiber surface or by etching the fiber surface in a predefined pattern (e.g., in a motheye pattern or any other suitable nanostructure pattern), superior AR properties may be achieved as compared to traditional AR coatings. Such surfaces offer reduced back reflection, superior damage threshold, efficient operation over a broad wavelength range with low angular dependence, and usage in both high and low-power applications.

Considering the higher efficacy of the motheye etching process over the traditional AR coatings, the present disclosure proposes the design of a fifth coupler in which the MFA surface that faces the HCF portion is etched by using a motheye etching process.

It is known that in the motheye etching process, the fiber surface is etched proportional to the refractive index distribution or germanium (Ge) dopant profile of the optical fiber. Therefore, if the motheye etching process is performed on the GRIN surface that faces the HCF portion, the GRIN surface would be etched proportional to the Ge dopant profile of the GRIN portion. The GRIN portion typically has a high Ge dopant concentration, and hence if the motheye etching process is performed on the GRIN surface, the mode output from the GRIN may be distorted, which may lead to significant signal loss. To mitigate this challenge, the fifth coupler additionally includes (in addition to the components of the first coupler described above) a secondary fiber portion, which may be a low Numerical Aperture (NA) fiber portion or a coreless fiber portion. One end of the secondary fiber portion may be attached to the GRIN portion (e.g., by fusion splicing or an adhesive) and the other end may face the HCF portion.

It is known that an NA of a fiber is defined by the mathematical expression,

$$NA = \sqrt{( {n}_{core}^{2} - {n}_{cladding}^{2} )} ;$$

where n_{core} and n_{cladding} are the refractive indices of the core and the cladding respectively. The NA of the GRIN portion varies along its radius because of the gradually decreasing refractive index from the center outward. On the other hand, the difference between n_{core} and n_{cladding} is quite small in the low NA fiber portion, and hence the NA of the low NA fiber portion is considerably smaller than the NA of the GRIN portion. Furthermore, since the difference between n_{core} and n_{cladding} is small in the low NA fiber portion, the refractive index distribution is also lower in the low NA fiber portion as compared to the GRIN portion.

In the fifth coupler, if the secondary fiber portion is a low NA fiber portion, the low NA fiber surface that faces the HCF portion may be coated with an AR coating or etched by using the motheye etching process. As described above, the low NA fiber has substantially low refractive index distribution/Ge dopant profile than the GRIN portion, and hence the low NA fiber surface that faces the HCF portion does not cause any significant signal distortion when etched by using the motheye etching process. Specifically, the low NA fiber preserves the mode from the MFA/GRIN and reduces the level/gradient of the Ge dopant. The low Ge dopant level/gradient of the Low NA fiber mitigates the impact of the motheye process on the mode field and minimizes loss. In this manner, the fifth coupler integrates the motheye surface/coating into the MFA design, which further reduces the back reflection between the SMF portion and the HCF portion.

In alternative embodiments, as described above, the secondary fiber portion may be a coreless fiber portion. It is known that in a coreless fiber, there is no core and the entire cross-section of the coreless fiber is made of a uniform refractive index material (with no doping), typically pure silica or glass. In the fifth coupler, if the secondary fiber portion is a coreless fiber portion, the coreless fiber surface that faces the HCF portion may be coated with an AR coating or etched by using the motheye etching process. It has been observed that if motheye etching is performed on the coreless fiber surface, the motheye does not distort the surface much. Specifically, in the case of the coreless fiber portion, since there is no core and the refractive index is uniform, the etched surface of the coreless fiber remains substantially flat and hence is not distorted (since there is no refractive index step in the coreless fiber), except for the microtextures or nanostructures that are formed on the surface.

Since the coreless fiber surface that is etched by using the motheye etching process remains substantially flat, in the fifth coupler, the coreless fiber surface that is etched by using the motheye etching process may be fusion spliced with the HCF portion. In this case, the “flat” etched surface is observed to be more robust to fusion splicing (as opposed to a scenario where the GRIN surface is motheye etched and then spliced to the HCF portion), and hence in the fifth coupler, it is possible to fusion splice the coreless fiber portion with the HCF portion. In other embodiments, the coreless fiber surface that is etched may be bonded to the HCF portion using an adhesive.

In accordance with further embodiments of the present disclosure, a design of a sixth coupler is disclosed in which the end of the secondary fiber portion (the low NA fiber portion or the coreless fiber portion), which is coated with an AR coating or etched by using the motheye etching process, is kept a predefined distance away from the HCF portion so that a gap may exist between the secondary fiber portion and the HCF portion. In this case, the sixth coupler may additionally include the mechanical enclosure described above that may enclose the GRIN portion, the secondary fiber portion, the gap, and predefined parts or lengths of the SMF portion and the HCF portion.

In accordance with further embodiments of the present disclosure, a design of a seventh coupler is disclosed in which the GRIN portion (and the secondary fiber portion described above) may not be present between the SMF portion and the HCF portion. Instead, in the seventh coupler, a metasurface may be added to the end of the SMF portion that faces the HCF portion. In the seventh coupler, the metasurface may act as a holographic optical element, which performs the function of intensity and phase transformation of the effective “lens” that is formed between the SMF portion and the HCF portion. Basically, the metasurface acts as a phase transforming device in the seventh coupler. In a way, adding a metasurface between the SMF portion and the HCF portion is similar to adding a GRIN between the SMF portion and the HCF portion. The metasurface helps with the lensing effect and also reduces/suppresses back-reflection at the SMF-HCF interface.

In the seventh coupler, the metasurface may be kept a predefined distance away from the HCF portion so that a gap may exist between the metasurface and the HCF portion. In this case as well, the seventh coupler may additionally include the mechanical enclosure described above that may enclose the metasurface, the gap, and predefined parts or lengths of the SMF portion and the HCF portion.

In accordance with further embodiments of the present disclosure, a design of an eighth coupler is disclosed, which may be similar to the seventh coupler described above; however, in the eighth coupler, the metasurface may be replaced by a lens (e.g., a ball lens). Stated another way, in the eighth coupler, a lens may be added to or molded at the end of the SMF portion that faces the HCF portion. The curvature of the lens may be optimized to provide the best performance (in terms of reducing back reflection, scattering and distortion of signals at the SMF-HCF interface). In an exemplary aspect, the lens may be made of a coreless fiber. For example, in this case, the coreless fiber can be melted to form a shape of a lens (e.g., like a spherical ball lens). The ball lens may help with the lensing or imaging of the optical signals from the SMF portion to the HCF portion. An AR coating may be applied or motheye etching may be performed at the surface of the lens that faces the HCF portion to reduce back-reflection of optical signals into the SMF portion.

In the eighth coupler, the lens may be kept a predefined distance away from the HCF portion so that a gap may exist between the lens and the HCF portion. In this case as well, the eighth coupler may additionally include the mechanical enclosure described above that may enclose the lens, the gap, and predefined parts or lengths of the SMF portion and the HCF portion.

In accordance with further embodiments of the present disclosure, a design of a ninth coupler is disclosed, which may be an HCF-to-HCF coupler. In this case, a lens or metasurface may be added to an end of one HCF that faces the other HCF. The metasurface or the lens may perform the same function in the ninth coupler as the function of these components described above. In a way, the ninth coupler may be similar to the seventh and eighth coupler described above, but may have the metasurface or the lens added to the end of the HCF portion (as opposed to the end of the SMF portion described above).

The ninth coupler may be used in high power applications, when a high power signal is transmitted through the HCFs coupled via the ninth coupler. In some aspects, the ninth coupler may also be used for SMF-to-HCF coupling.

In accordance with yet another embodiment of the present disclosure, a design of a tenth coupler is disclosed that may include the SMF portion and the HCF portion described above. In the tenth coupler, a central longitudinal axis of the SMF portion is disposed at a non-zero offset from a central longitudinal axis of the HCF portion. Stated another way, in the tenth coupler, the central axes of the SMF and HCF portions may not be aligned, but may be disposed at a non-zero offset from each other. The tenth coupler may additionally include one or more reflective surfaces that may enable an optical signal output from the SMF portion to enter the HCF portion or enable an optical signal output from the HCF portion to enter the SMF portion. One or more air-glass interfaces in the tenth coupler may be AR coated, to reduce back-reflection at these interfaces.

In accordance with further embodiments of the present disclosure, a design of an eleventh coupler is disclosed, which may be similar to the second coupler described above; however, in the eleventh coupler, the GRIN surface that faces the HCF portion is “engineered” by coating the surface with a dielectric coating and then processing the dielectric coating to produce an etched or textured surface. The coating may include SiO₂, TiO₂, MgF₂, or any other suitable dielectric material. For example, a SiO₂ dielectric coating, which may be referred to as a passivation layer, may be deposited onto the GRIN surface, and then the coating may be etched (e.g., using a motheye etching process) or otherwise processed to form microtextures or nanostructures on the surface of the coating. The textured surface of the dielectric coating may help to reduce or suppress back-reflection of light from the GRIN surface.

Further coupler details are described below in conjunction with the drawings figures.

Turning now to the figures, FIG. 1 depicts a schematic diagram of a first example coupler 100 to connect a single mode fiber (SMF) with a hollow core fiber (HCF) in accordance with one or more embodiments of the present disclosure. The coupler 100 may include an SMF portion 102 (or SMF pigtail), a GRIN portion 104 and an HCF portion 106 (or HCF pigtail). In an exemplary embodiment, the SMF portion 102 and the HCF portion 106 may have lengths of approximately 1-3 meters each, and the GRIN portion 104 may have a length in the range of 260-300 micrometer.

The HCF portion 106, as described in the present disclosure, may include a hollow core and one or more anti-resonant elements. It is known that in anti-resonant HCFs, light is guided in the hollow core as a result of anti-resonant properties of thin walled structures extending along the length of the fiber. In some aspects, the HCF portion 106 may incorporate any hollow core fiber design such as, but not limited to, antiresonant fibers, antiresonant slab fibers, photonic bandgap fibers, Kagome fibers, nested antiresonant nodeless hollow core fibers (NANFS), or double nested antiresonant nodeless hollow core fibers (DNANFS). Two example cross-sectional structures of the HCF portion 106 are shown in FIG. 1 as HCFs 108a and 108b.

In some embodiments, the HCF 108a may include one or more cladding structures 110 providing a hollow interior region 112. In the example embodiment depicted in FIG. 1, the HCF 108a includes a single one of the cladding structures 110 formed as a circular tube. In some embodiments, the HCF 108a may further include multiple AR elements 114 distributed in the hollow interior region 112 provided by the cladding structure 110. As an illustration, the HCF 108a is depicted to include seven sets of nested AR elements 114, where each of the nested AR elements 114 includes one AR element within another AR element. In some embodiments, the HCF 108a further includes one or more support structures 116, which may position at least one AR element within the HCF 108a. For example, at least one of the AR elements 114 may be connected to at least one support structure 116. The support structures 116 may generally be formed as or be in contact with the cladding structure 110 and/or any of the AR elements 114.

In further embodiments, the HCF 108b may be substantially similar in structure to the HCF 108a, except that a single “offset” second AR element 114b may be located within the interior region of a first AR element 114a. Stated another way, the second AR element 114b may not be symmetrically placed within the first AR element 114a and is thus not centered on a radial line 118 from the center of the HCF 108b.

The example cross-sectional structures of the HCFs 108a, 108b depicted in FIG. 1 should not be construed as limiting. The cross-sectional structures of the HCF 108a, 108b are depicted in FIG. 1 just for illustrative purpose, and the HCF portion 106 may have a different cross-sectional structure, without departing from the scope of the present disclosure. Further example HCF cross-sectional structures are depicted in U.S. patent application Ser. No. 18/662,573, filed on May 13, 2024, which is incorporated by reference in its entirety in the present disclosure.

As described above, in the GRIN portion 104, the refractive index of the core gradually decreases from the center to the outer edge rather than having a uniform value. This is in contrast to the SMF portion 102, in which the refractive index changes abruptly from the core to the cladding layer. In accordance with the present disclosure, in the coupler 100, the GRIN portion 104 may be disposed between the SMF portion 102 and the HCF portion 106, and may touch or abut both the SMF portion 102 and the HCF portion 106, as shown in FIG. 1. The GRIN portion 104 reduces the mode field size mismatch between the SMF portion 102 and the HCF portion 106, thereby reducing connection and insertion losses, back reflection and diffraction.

In some aspects, the SMF portion 102 may include an SMF proximal end 120 and an SMF distal end 122, and the HCF portion 106 may include an HCF proximal end 124 and an HCF distal end 126. Further, the GRIN portion 104 may include a GRIN proximal end or surface that may touch the SMF distal end 122. Specifically, the GRIN proximal end may be attached to the SMF distal end 122 by fusion splicing or by using an adhesive. Furthermore, in the coupler 100, a GRIN distal end or surface may touch the HCF proximal end 124. Specifically, the GRIN distal end or surface may be attached to the HCF proximal end 124 by fusion splicing or by using an adhesive. In this manner, the GRIN portion 104 may be secured between the SMF portion 102 and the HCF portion 106 in the coupler 100, and may efficiently act as a beam-shaping and mode-matching element (or as a mode field adaptor, “MFA”) between the SMF portion 102 and the HCF portion 106, which reduces insertion loss and back reflection of optical signals at the SMF-HCF interface, as described above.

The SMF proximal end 120 may be spliced or connected with an SMF cable end (e.g., a data center's SMF cable end), and the HCF distal end 126 may be spliced or connected with an HCF cable end. In this manner, a field operator may conveniently connect an SMF cable of a data center with an HCF cable by using the coupler 100, without having to splice an SMF to an HCF in the field, which is known to be a challenging task. By using the coupler 100, the operator may conveniently fusion splice or mechanically connect (e.g., via a mechanical connector) the SMF proximal end 120 with the data center's SMF cable end (which is a relatively simpler process as it involves connecting SMF-to-SMF), and the HCF distal end 126 with the HCF cable end (which is also a relatively simpler process as it involves connecting HCF-to-HCF).

While the coupler 100 significantly reduces the optical signal back reflection at the SMF-HCF interface by incorporating the GRIN portion 104 in between the SMF and HCF portions 102, 106, further modifications in the coupler design may result in even lower back reflection, as described below in conjunction with subsequent figures.

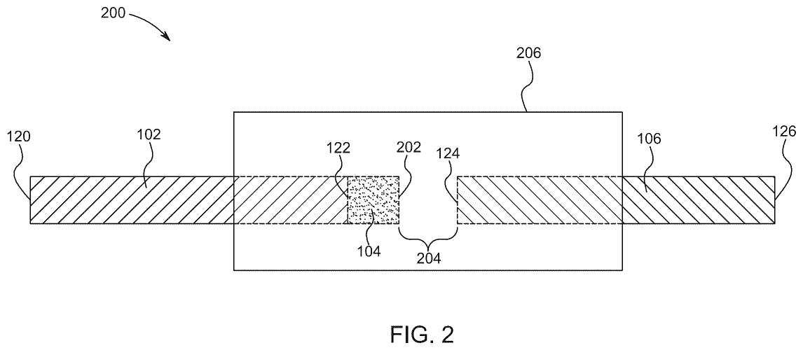

FIG. 2 depicts a schematic diagram of a second example coupler 200 to connect an SMF with an HCF in accordance with one or more embodiments of the present disclosure. The coupler 200 may be similar to the coupler 100 and may have the SMF portion 102, the GRIN portion 104 and the HCF portion 106; however, in the coupler 200, a GRIN distal end 202 (or surface) that faces the HCF proximal end 124 may be “engineered” by coating it with an AR coating (e.g., a dielectric coating). Further, in the coupler 200, the GRIN distal end 202 may not be fusion spliced with the HCF proximal end 124, but rather kept a predefined distance away from the HCF proximal end 124 such that a gap 204 may be formed between the GRIN distal end 202 and the HCF proximal end 124. The connection between the GRIN proximal end and the SMF distal end 122 may be the same as the connection described above in conjunction with the coupler 100. Stated another way, in the coupler 200, the GRIN proximal end may be attached to the SMF distal end 122 by fusion splicing or by using an adhesive. In embodiments, the GRIN portion 104 and the HCF portion 106 may be angled surfaces with angles that are not right angles as depicted in FIG. 2. In FIG. 2, the GRIN distal end 202 and the HCF proximal end 124 are non-angled (i.e., the surface normal of the end surface of the GRIN portion is parallel to the central axis of the GRIN portion, and the surface normal of the end surface of the HCF portion is parallel to the central axis of the HCF portion). In alternative embodiments, the GRIN portion 104 or the HCF portion 106 may have an angled end surface (i.e., the surface normal of the end surface of the distal end 202 of the GRIN portion 104 may be angled with respect to the central axis of the GRIN portion, or the surface normal of the proximal end 124 of the HCF portion 106 may be angled with respect to the central axis of the HCF portion). For example, the end surface of the distal end 202 of the GRIN portion 104 or the proximal end 124 of the HCF portion 106 may be angled at 3-15 degrees.

Coating the GRIN distal end 202 with an AR coating significantly reduces the back reflection at the MFA-HCF interface, and hence considerably improves the performance of the coupler 200. However, as described above, fusion splicing a surface coated with an AR coating adversely affects the AR coating layer. Therefore, in the coupler 200, the GRIN distal end 202 is not fusion spliced with the HCF proximal end 124, but is rather kept a predefined distance away from the HCF portion 106 so that the gap 204 may be maintained. The gap 204 may cause some small amount of connection loss in the coupler 200, but, as described above, the gain in terms of reducing the back reflection is substantial (due to the AR coating at the GRIN distal end 202 that faces the HCF portion 106). In some aspects, the coupler 200 may include a mechanical stop point or a physical stop (not shown, which may be present at the point where the HCF proximal end 124 is depicted in FIG. 2) which may prevent the motion of the HCF portion 106 towards the GRIN portion 104. Specifically, the physical stop may prevent the motion of the HCF portion 106 towards the GRIN portion 104 during the coupler manufacturing process, so that the HCF portion 106 would be inserted/placed into a correct position and the gap 204 may be maintained between the HCF proximal end 124 and the GRIN distal end 202. Additionally, the coupler 200 may include a physical stop to prevent the motion of the GRIN portion 104 towards the HCF portion 106.

In some aspects, the gap 204 may be filled with air. In other aspects, the gap 204 may be filled with a predetermined gas (e.g., nitrogen, argon, or any other suitable gas or gas mixture). Further, in certain embodiments, the gap 204 may have a predefined length, which may be in a range of 10 micrometers to 1 millimeter. In other embodiments, the length of the gap 204 may be based on the numerical apertures of the GRIN portion 104 and/or the HCF portion 106. In an ideal scenario, the mode field diameter and the numerical aperture of the GRIN portion 104 are equivalent to the mode field diameter and the numerical aperture of the HCF portion 106.

The coupler 200 may further include a mechanical enclosure 206 that may secure the arrangement of the SMF-GRIN-Air Gap-HCF described above and as shown in FIG. 2. The mechanical enclosure 206 may be a sealed package that may robustly secure this entire arrangement, and may not allow air or any foreign particle to enter the interior portion of the mechanical enclosure 206. Some predefined parts or lengths (e.g., 5-15%) of the SMF portion 102 and the HCF portion 106 may be disposed inside the mechanical enclosure 206, and the remaining parts/lengths may be disposed outside the mechanical enclosure 206. In an exemplary embodiment, the SMF distal end 122 and the HCF proximal end 124 may be disposed inside the mechanical enclosure 206, and the SMF proximal end 120 and the HCF distal end 126 may be disposed outside the mechanical enclosure 206 (to enable the operator to conveniently connect the SMF proximal end 120 with a data center's SMF and the HCF distal end 126 to an HCF cable). Further, the GRIN portion 104 and the gap 204 may be disposed inside the mechanical enclosure 206, to robustly secure the SMF-GRIN-Air Gap-HCF interface inside the mechanical enclosure 206.

In addition to securing the interface described above, the mechanical enclosure 206 facilitates in maintaining optimal alignment between the SMF portion 102, the GRIN portion 104 (or MFA) and the HCF portion 106.

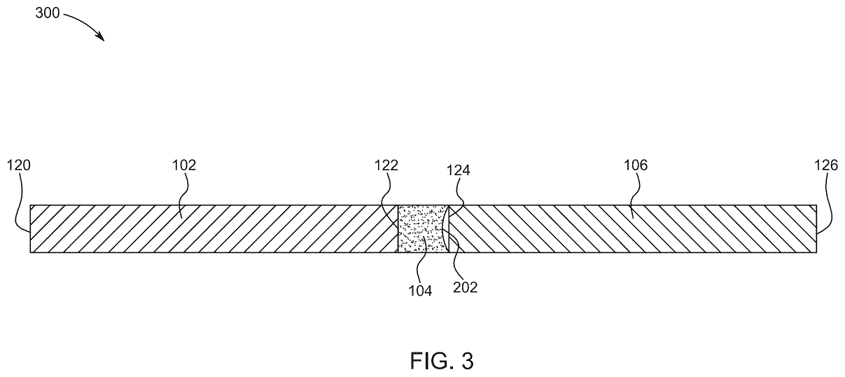

FIG. 3 depicts a schematic diagram of a third example coupler 300 to connect an SMF with an HCF in accordance with one or more embodiments of the present disclosure. The coupler 300 may be similar to the coupler 100 described above; however, in the coupler 300, the GRIN distal end 202 may be engineered by etching a parabolic divot or a negative lens at the GRIN distal end 202, as shown in FIG. 3.

As described above, the profile or curvature of the parabolic divot at the GRIN distal end 202 may be based on the doping profile of the GRIN portion 104. Specifically, as described above, the GRIN portion 104 may have a parabolic doping profile or distribution in which the dopant concentration is highest at the center portion of the cross-section of the GRIN portion 104, and the dopant concentration gradually decreases towards the outer edge of the GRIN portion 104. Therefore, the etching of the parabolic divot is more pronounced at the center portion of the GRIN portion 104, as shown in FIG. 3.

Further, as described above, the doping profile or concentration of the GRIN portion 104 may itself be engineered or modified so that the profile or curvature of the parabolic divot matches with an optimal curvature that focuses the optical signals output from the SMF portion 102 to the hollow core of the HCF portion 106. Stated another way, the dopant profile of the GRIN portion 104 may be engineered based on the etching profile of the parabolic divot that is required or is expected to provide the best performance (in terms of reducing back reflection, scattering and distortion of signals at the GRIN-HCF interface).

In the exemplary embodiment depicted in FIG. 3, the GRIN distal end 202 or the parabolic divot touches the HCF proximal end 124. Specifically, the GRIN distal end 202 or the parabolic divot may be attached to the HCF proximal end 124 by fusion splicing or by using an adhesive.

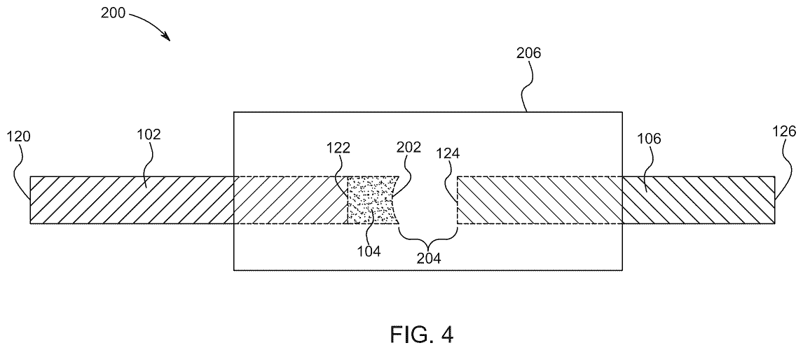

FIG. 4 depicts a schematic diagram of a fourth example coupler 400 to connect an SMF with an HCF in accordance with one or more embodiments of the present disclosure. The coupler 400 may be substantially similar to the coupler 300 described above; however, in the coupler 400, the GRIN distal end 202 or the parabolic divot is kept a predefined distance away from the HCF portion 106 so that a gap 204 may exist between the GRIN distal end 202 and the HCF proximal end 124. The coupler 400 may additionally include the mechanical enclosure 206 that may enclose the GRIN portion 104 (containing the parabolic divot), the gap 204, and predefined parts or lengths of the SMF portion 102 and the HCF portion 106.

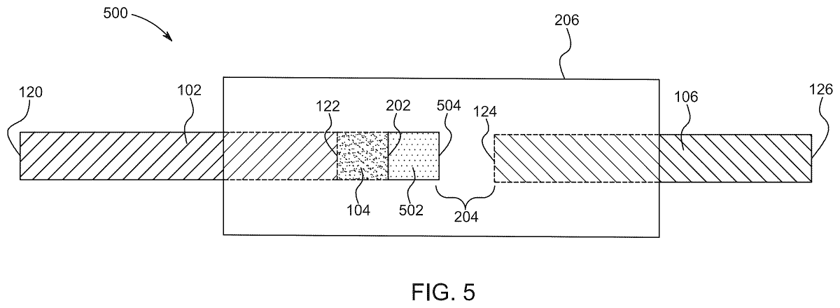

FIG. 5 depicts a schematic diagram of a fifth example coupler 500 to connect an SMF with an HCF in accordance with one or more embodiments of the present disclosure. The coupler 500 may be similar to the coupler 200 described above; however, instead of having the GRIN distal end 202 coated with an AR coating, the end/surface of the MFA that faces the gap 204/HCF proximal end 124 may be engineered to reduce back-reflection. The end/surface of the MFA may be engineered by etching it using a motheye etching process.

As described above, engineering the MFA end/surface that faces the gap 204/HCF proximal end 124 in a predefined pattern (e.g., in a motheye pattern) considerably enhances the AR properties of the surface, and further offers reduced back reflection, superior damage threshold, efficient operation over a broad wavelength range with low angular dependence, and usage in both high and low-power applications. However, in the motheye etching process, the fiber surface is etched proportional to the refractive index distribution or Ge dopant profile of the optical fiber. The GRIN portion 104 is known to have a large proportion of Ge doping. Therefore, if the motheye etching process is performed on the GRIN distal end 202 (or surface), the mode field of the GRIN portion 104 may get distorted or the GRIN distal end 202 may become deformed or damaged. To prevent such a scenario from occurring, the coupler 500 includes a secondary fiber portion 502, which may be a low NA fiber portion or a coreless fiber portion. The secondary fiber portion 502 may have a secondary fiber proximal end and a secondary fiber distal end 504. The secondary fiber proximal end may be attached to the GRIN distal end 202 by fusion splicing or by using an adhesive, and the secondary fiber distal end 504 may be engineered to reduce back-reflection. In some aspects, the secondary fiber distal end 504 may be engineered by applying an AR coating to the secondary fiber distal end 504. In other aspects, the secondary fiber distal end 504 may be engineered by etching the secondary fiber distal end 504 using a motheye etching process. In an exemplary aspect, a length of the secondary fiber portion 502 may be in a range of 0.5-1.5 mm.

As described above, the low NA fiber portion has some germanium dopants but the dopant concentration may be much lower than the Ge concentration in the GRIN portion 104. Therefore, the motheye etching is more efficient on the low NA fiber portion as compared to the GRIN portion 104. Specifically, the low NA fiber portion does not deform during the motheye etching process. This, in a way, “protects” the GRIN portion 104 from the motheye process and helps to maintain the mode field of the GRIN portion 104.

Further, the coreless fiber portion has no core and the entire cross-section of the coreless fiber is made of a uniform refractive index material (with no doping), typically pure silica or glass. If the motheye etching is performed on the coreless fiber surface, the motheye does not distort the surface much. Specifically, in the case of the coreless fiber portion, since there is no core and the refractive index is uniform, the etched surface of the coreless fiber remains substantially flat and hence is not distorted (since there is no refractive index step in the coreless fiber), except for the microtextures or nanostructures that are formed on the surface.

It may be appreciated from the description above that by including the secondary fiber portion 502 (the low NA fiber portion or the coreless fiber portion) in the coupler 500, the advantages of the motheye structure may be incorporated in the coupler design, without adversely affecting the mode field of the GRIN portion 104. Such a coupler design further reduces the back reflection between the SMF portion 102 and the HCF portion 106, and hence provides enhanced optical signal transmission properties to the coupler.

In the exemplary embodiment depicted in FIG. 5, the secondary fiber distal end 504 is kept a predefined distance away from the HCF proximal end 124 so that the gap 204 (of a predefined non-zero length) may be present between the secondary fiber distal end 504 and the HCF proximal end 124. The coupler 500 may additionally include the mechanical enclosure 206 that may enclose the GRIN portion 104, the secondary fiber portion 502, the gap 204, and predefined parts or lengths of the SMF portion 102 and the HCF portion 106.

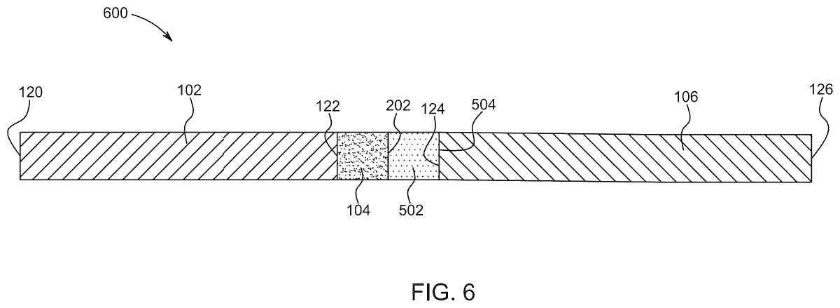

FIG. 6 depicts a schematic diagram of a sixth example coupler 600 to connect an SMF with an HCF in accordance with one or more embodiments of the present disclosure. The coupler 600 may be similar to the coupler 500 described above; however, in the coupler 600, the secondary fiber distal end 504 may be attached to the HCF proximal end 124 by fusion splicing or by using an adhesive. Further, the coupler 600 may not include a mechanical enclosure 206.

As described above, if the secondary fiber portion 502 is a coreless fiber portion, the motheye etching does not distort the coreless fiber surface much and the surface remains substantially flat. This “flat” etched surface of the coreless fiber portion is observed to be more robust to fusion splicing, and hence in the coupler 600, it is possible to fusion splice the coreless fiber portion with the HCF portion 106.

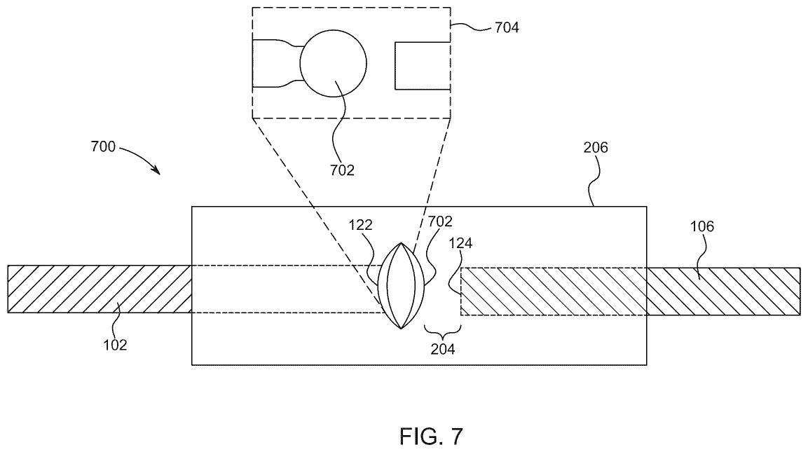

FIG. 7 depicts a schematic diagram of a seventh example coupler 700 to connect an SMF with an HCF in accordance with one or more embodiments of the present disclosure. The coupler 700 may include the SMF portion 102, the HCF portion 106 and the mechanical enclosure 206. The coupler 700 may further include a lens 702 (e.g., a ball lens, as shown in a view 704) that may be added or molded to the SMF distal end 122 (that faces the HCF proximal end 124. As described above, the curvature of the lens 702 may be optimized to provide the best performance (in terms of reducing back reflection, scattering and distortion of signals at the SMF-HCF interface). In an exemplary aspect, the lens 702 may be made of a coreless fiber. For example, in this case, the coreless fiber can be melted to form a shape of a lens (e.g., like a spherical ball lens). The ball lens may help with the lensing or imaging of the optical signals from the SMF portion 102 to the HCF portion 106. An AR coating may be applied or motheye etching may be performed at the surface of the lens 702 that faces the HCF portion 106 to reduce the back-reflection of optical signals into the SMF portion 102.

In the coupler 700, the lens 702 may be kept a predefined distance away from the HCF portion so that the gap 204 may exist between the lens 702 and the HCF proximal end 124. The mechanical enclosure 206 may enclose the lens 702, the gap 204, and predefined parts or lengths of the SMF portion 102 and the HCF portion 106, as shown in FIG. 7.

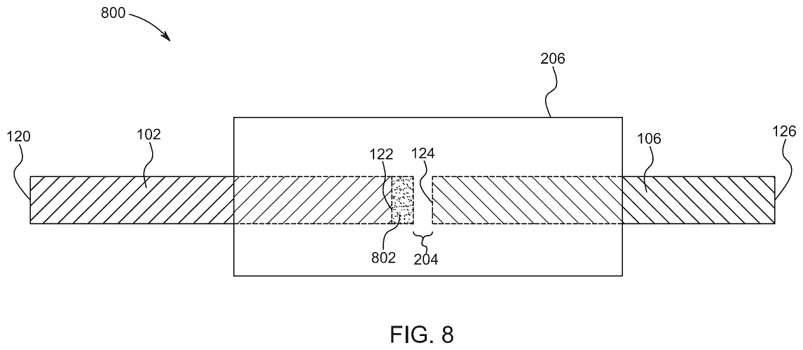

FIG. 8 depicts a schematic diagram of an eighth example coupler 800 to connect an SMF with an HCF in accordance with one or more embodiments of the present disclosure. The coupler 800 may be substantially similar to the coupler 700 described above; however, in the coupler 800, the lens 702 may be replaced by a metasurface 802. Specifically, in the coupler 800, the metasurface 802 may be added to the SMF distal end 122 (that faces the HCF portion 106). As described above, the metasurface 802 may act as a holographic optical element, which performs the function of intensity and phase transformation of the effective “lens” that is formed between the SMF portion 102 and the HCF portion 106.

In the coupler 800 as well, the metasurface 802 may be kept a predefined distance away from the HCF portion 106 so that the gap 204 may exist between the metasurface 802 and the HCF proximal end 124. The mechanical enclosure 206 may enclose the metasurface 802, the gap 204, and predefined parts or lengths of the SMF portion 102 and the HCF portion 106, as shown in FIG. 8.

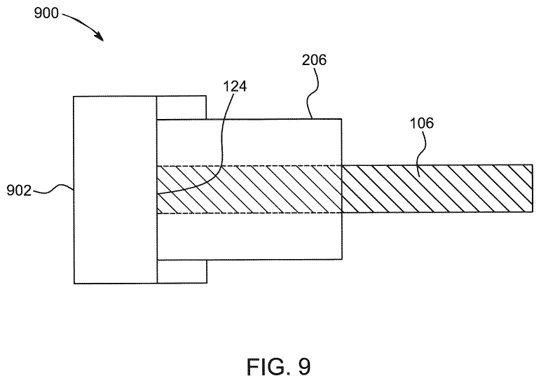

FIG. 9 depicts a schematic diagram of a ninth example coupler 900 to connect an HCF with another HCF in accordance with one or more embodiments of the present disclosure. The coupler 900 may include the HCF portion 106 and metasurface 902 (or metalens) that may be added to the HCF proximal end 124. The metasurface 902 (or metalens) may perform the same function in the coupler 900 as the function of these components described above in conjunction with the couplers 700, 800. In a way, the coupler 900 may be similar to the couplers 700, 800 described above, but may have the metasurface 902 (or metalens) added to the end of the HCF portion 106 (as opposed to the end of the SMF portion 102 described above). The coupler 900 may be connected to a similar coupler associated with another HCF portion, to enable connection between two HCFs.

The coupler 900 may be used in high power applications, when a high power signal is transmitted through the HCFs coupled via the coupler 900. In some aspects, the coupler 900 may also be used for SMF-to-HCF coupling.

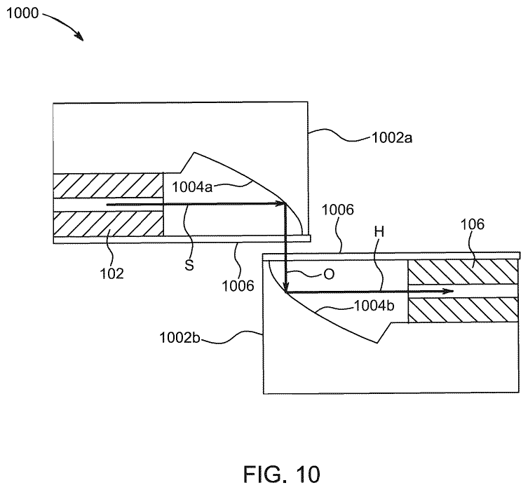

FIG. 10 depicts a schematic diagram of a tenth example coupler 1000 to connect an SMF with an HCF in accordance with one or more embodiments of the present disclosure. The coupler 1000 may include the SMF portion 102 and the HCF portion 106. The SMF portion 102 may be connected to or enclosed within a first metallic (e.g. Aluminum) optical bench 1002a, and the HCF portion 106 may be connected to or enclosed within a second metallic optical bench 1002b.

In the coupler 1000, a central axis “S” of the SMF portion 102 may be disposed at a non-zero offset “O” from a central axis “H” of the HCF portion 106, as shown in FIG. 10. Further, the optical benches 1002a, 1002b may include reflective surfaces 1004a, 1004b that may enable an optical signal output from the SMF portion 102 to enter the HCF portion 106 or enable an optical signal output from the HCF portion 106 to enter the SMF portion 102.

In an exemplary aspect, the area/space between the SMF portion 102 and the reflective surface 1004a may be filled with index-matching fluid for the SMF. This eliminates the glass-air interface at the SMF portion 102. The coupler 1000 may further include glass plates 1006 at the intersection of the optical benches 1002a, 1002b. The glass plates 1006 may be AR coated, to reduce back-reflection.

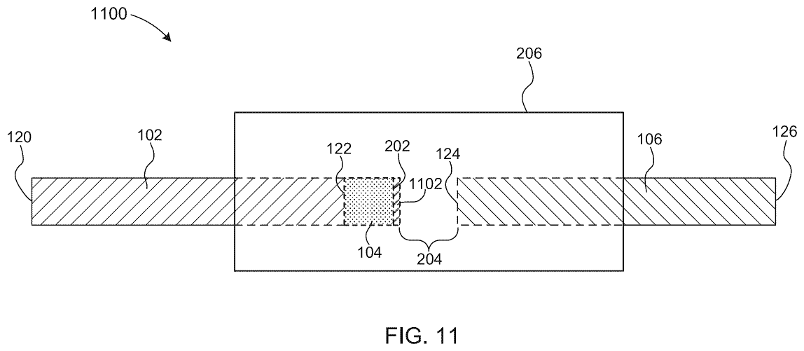

FIG. 11 depicts a schematic diagram of an eleventh example coupler 1100 to connect an SMF with an HCF in accordance with one or more embodiments of the present disclosure. The coupler 1100 may be similar to the coupler 200 described above; however, instead of having the GRIN distal end 202 uncoated or coated with an AR coating, the GRIN distal end 202 is coated with a dielectric coating 1102 and an etching process is applied to the dielectric coating 1102. For example, the dielectric coating 1102 may be engineered by etching it using a motheye etching process. The dielectric coating 1102 may include SiO₂, TiO₂, MgF₂, or any other suitable dielectric material. For example, a SiO₂ dielectric coating may be deposited onto the GRIN distal end 202, and then the coating may be etched or otherwise processed to form microtextures or nanostructures on the surface of the coating. The textured surface of the dielectric coating 1102 may help to reduce or suppress back-reflection of light from the GRIN distal end 202. Additionally, the dielectric coating 1102 acts as a barrier that prevents damage or deformation that may result from applying an etching process directly to the GRIN distal end 202.

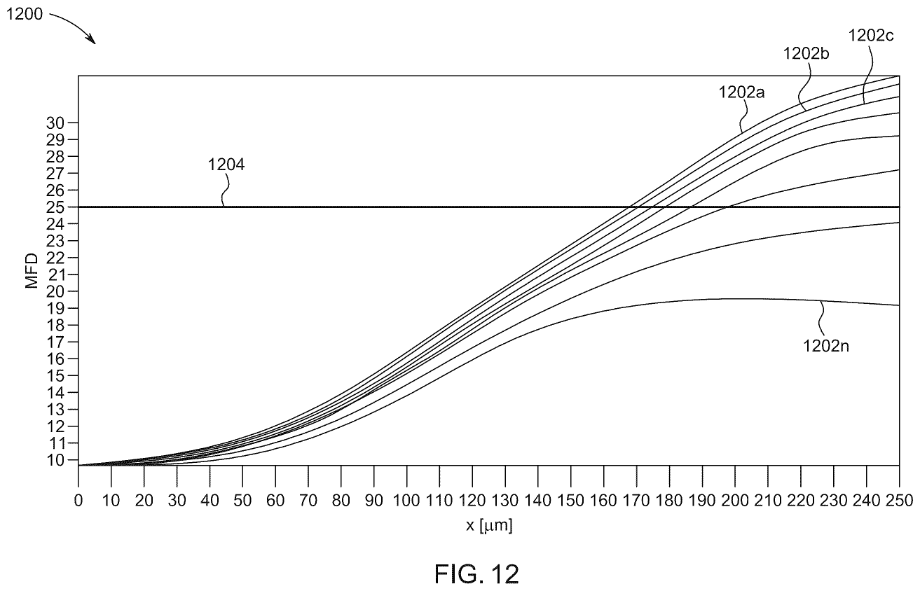

To ensure enhanced performance of one or more of the couplers as described above and to reduce connection losses, it is important that an optimal length of the GRIN portion 104 is used in the coupler or attached to the SMF portion 102. In some aspects, the length of the GRIN portion 104 may be based on a mode field diameter (MFD), a numerical aperture (NA), and/or a physical diameter of the SMF portion 102 and/or the HCF portion 106, a diameter of the GRIN portion 104, and/or a wavelength of the optical signal. An example graph 1200 between an MFD of the SMF portion 102 (shown in Y-axis (in μm)) and a length (shown in X-axis (in μm)) of the GRIN portion 104 for different GRIN core diameters is shown in FIG. 12. Lines 1202a, 1202b, 1202c, 1202n (collectively referred to as lines 1202) are associated with different GRIN core diameters, e.g., 40 μm, 50 μm, 60 μm, 70 μm, and so on. Further, the graph 1200 depicts the correspondence between the MFD of the SMF portion 102 and the GRIN length when the wavelength of the optical signal is 1550 nm. As may be appreciated, the lines 1202 may move up or down as the wavelength of the optical signal is changed.

An example MFD of the SMF portion 102 is shown as a line 1204. An optimal GRIN length can be easily identified from the graph 1200 by determining the intersection of the line 1204 with the line 1202 for a particular GRIN core diameter.

The graph 1200 is depicted just for illustrative purpose and should not be construed as limiting. An optimal length of the GRIN portion 104 may be identified by using any other method or by testing in the factory, without departing from the scope of the present disclosure.

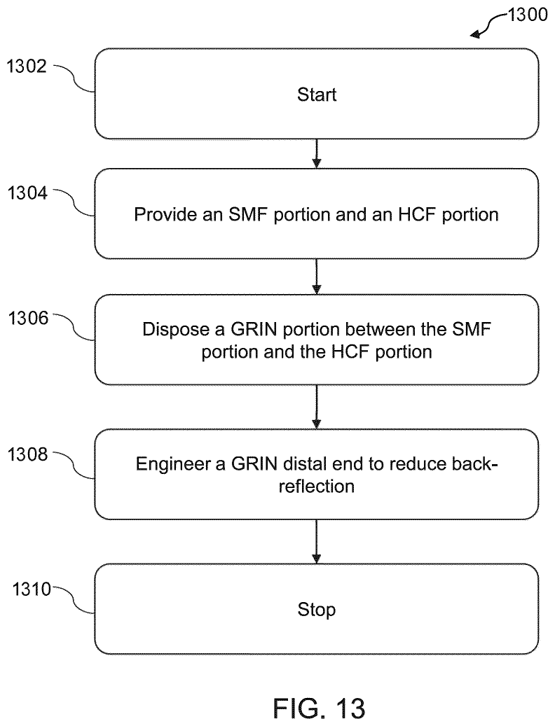

FIG. 13 is a flow diagram of a first example method 1300 to make a coupler to connect an SMF with an HCF in accordance with one or more embodiments of the present disclosure. Applicant notes that the embodiments and enabling technologies described previously herein in the context of the couplers 100-1100 should be interpreted to extend to the method 1300. It is further noted, however, that the method 1300 is not limited to the architecture/structure/operation of the couplers 100-1100 described above. Furthermore, the steps described in conjunction with the method 1300 may be performed by an operator or a controller/processor.

The method 1300 may start at step 1302. At step 1304, the method 1300 may include providing an SMF portion 102 and an HCF portion 106. At step 1306, the method 1300 may include disposing a GRIN portion 104 between the SMF portion 102 and the HCF portion 106. At step 1308, the method 1300 may include engineering the GRIN distal end 202 to reduce back-reflection. As described above, the GRIN distal end 202 may be coated with an AR coating or etched to form the parabolic divot.

The method 1300 may end at step 1310.

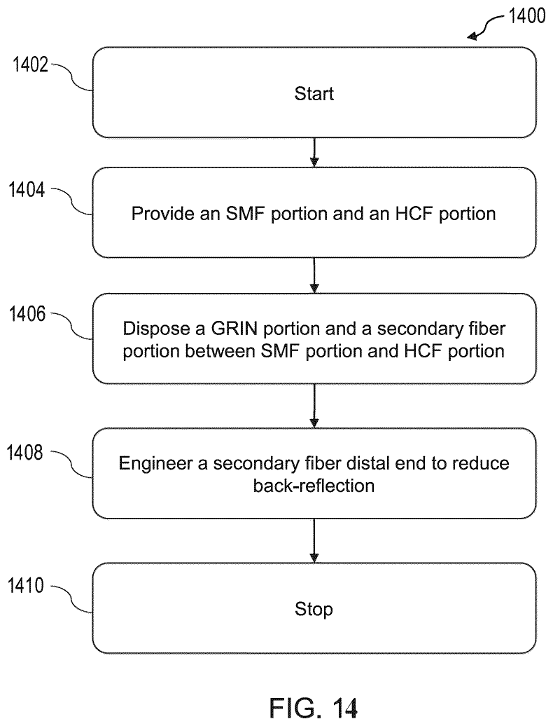

FIG. 14 is a flow diagram of a second example method 1400 to make a coupler to connect an SMF with an HCF in accordance with one or more embodiments of the present disclosure. Applicant notes that the embodiments and enabling technologies described previously herein in the context of the couplers 100-1100 should be interpreted to extend to the method 1400. It is further noted, however, that the method 1400 is not limited to the architecture/structure/operation of the couplers 100-1100 described above. Furthermore, the steps described in conjunction with the method 1400 may be performed by an operator or a controller/processor.

The method 1400 may start at step 1402. At step 1404, the method 1400 may include providing an SMF portion 102 and an HCF portion 106. At step 1406, the method 1400 may include disposing a GRIN portion 104 and a secondary fiber portion 502 (e.g., the low NA fiber portion or the coreless fiber portion) between the SMF portion 102 and the HCF portion 106, as described above. At step 1408, the method 1400 may include engineering the secondary fiber distal end 504 to reduce back-reflection. As described above, the secondary fiber distal end 504 may be coated with an AR coating or etched by using motheye etching process.

The method 1400 may end at step 1410.

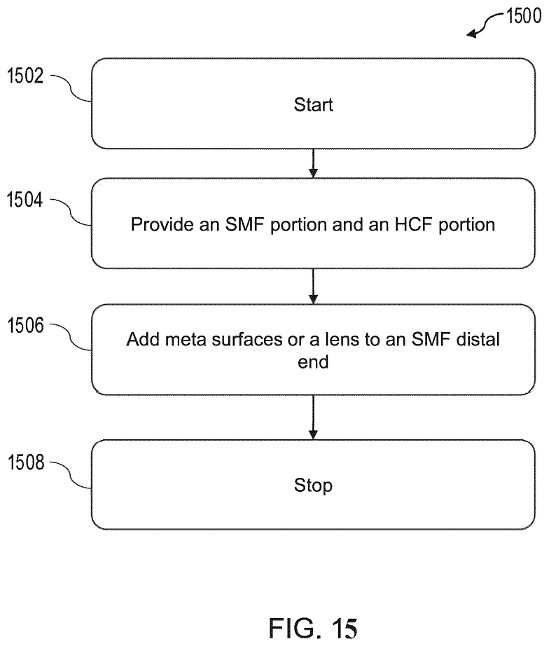

FIG. 15 is a flow diagram of a third example method 1500 to make a coupler to connect an SMF with an HCF in accordance with one or more embodiments of the present disclosure. Applicant notes that the embodiments and enabling technologies described previously herein in the context of the couplers 100-1100 should be interpreted to extend to the method 1500. It is further noted, however, that the method 1500 is not limited to the architecture/structure/operation of the couplers 100-1100 described above. Furthermore, the steps described in conjunction with the method 1500 may be performed by an operator or a controller/processor.

The method 1500 may start at step 1502. At step 1504, the method 1500 may include providing an SMF portion 102 and an HCF portion 106. At step 1506, the method 1500 may include adding a lens 702 or a metasurface 802 to the SMF distal end 122, as described above.

The method 1500 may end at step 1508.

Various embodiments are described by the following clauses. Any of the various features discussed with any one of the embodiments discussed herein may also apply to and be used with any other embodiments.

Clause 1. A coupler comprising: a mechanical enclosure; a single mode fiber (SMF) portion and a hollow core fiber (HCF) portion, wherein predefined parts or lengths of the SMF portion and the HCF portion are disposed inside the mechanical enclosure; and a graded index fiber (GRIN) portion disposed inside the mechanical enclosure and between the SMF portion and the HCF portion, wherein the GRIN portion touches the SMF portion and a gap exists between the GRIN portion and the HCF portion.

Clause 2. The coupler of clause 1, wherein the SMF portion comprises an SMF proximal end and an SMF distal end, wherein the HCF portion comprises an HCF proximal end and an HCF distal end, wherein the SMF distal end and the HCF proximal end are disposed inside the mechanical enclosure, and wherein the SMF proximal end and the HCF distal end are disposed outside the mechanical enclosure.

Clause 3. The coupler of clause 2, wherein the GRIN portion comprises a GRIN proximal end and a GRIN distal end, wherein the GRIN proximal end touches the SMF distal end, and wherein the gap exists between the GRIN distal end and the HCF proximal end.

Clause 4. The coupler of clause 3, wherein the GRIN proximal end is attached to the SMF distal end by fusion splicing or by using an adhesive.

Clause 5. The coupler of clause 3, wherein the GRIN distal end is coated with an anti-reflection (AR) coating.

Clause 6. The coupler of clause 3, further comprising a low numerical aperture (NA) fiber portion disposed between the HCF portion and the GRIN portion in the mechanical enclosure.

Clause 7. The coupler of clause 6, wherein the low NA fiber portion comprises a low NA fiber proximal end and a low NA fiber distal end, wherein the low NA fiber proximal end touches the GRIN distal end, and wherein the gap exists between the low NA fiber distal end and the HCF proximal end.

Clause 8. The coupler of clause 7, wherein the low NA fiber proximal end is attached to the GRIN distal end by fusion splicing or by using an adhesive.

Clause 9. The coupler of clause 7, wherein the low NA fiber distal end is coated with an AR coating.

Clause 10. The coupler of clause 7, wherein the low NA fiber distal end is etched using a motheye etching process.

Clause 11. The coupler of clause 1, further comprising an alignment groove disposed in the mechanical enclosure, wherein the alignment groove is configured to enable optimal optical alignment between the GRIN portion and the HCF portion.

Clause 12. The coupler of clause 11, wherein the alignment groove is made by using Silicon Optical Bench (SiOB).

Clause 13. The coupler of clause 1, wherein the gap has a predefined length.

Clause 14. The coupler of clause 1, wherein the gap is filled with air.

Clause 15. The coupler of clause 1, wherein the gap is filled with a predetermined gas.

Clause 16. The coupler of clause 2, wherein the SMF proximal end is configured to be connected to an SMF cable end and wherein the HCF distal end is configured to be connected to an HCF cable end.

Clause 17. The coupler of clause 16, wherein the SMF cable end is part of a data center.

Clause 18. The coupler of clause 16, wherein the SMF proximal end is connected to the SMF cable end by fusion splicing or by using a mechanical connector, and wherein the HCF distal end is connected to the HCF cable end by fusion splicing or by using a mechanical connector.

Clause 19. The coupler of clause 1, wherein a length of the GRIN portion is based on at least one of: a mode field diameter of the SMF portion or the HCF portion, a numerical aperture of the HCF portion or the SMF portion, a physical diameter of the HCF portion or the SMF portion, or a diameter of the GRIN portion.

Clause 20. The coupler of clause 1, wherein a central axis of the GRIN portion is aligned with a central axis of the SMF portion.

Clause 21. The coupler of clause 1, wherein a central axis of the GRIN portion is disposed with an offset relative to a central axis of the SMF portion.

Clause 22. A coupler comprising: a single mode fiber (SMF) portion; a hollow core fiber (HCF) portion; and a graded index fiber (GRIN) portion, wherein: the GRIN portion is disposed between the SMF portion and the HCF portion, and the GRIN portion touches both the SMF portion and the HCF portion.

Clause 23. The coupler of clause 22, further comprising a mechanical enclosure, wherein predefined parts or lengths of the SMF portion and the HCF portion are disposed inside the mechanical enclosure, and wherein the GRIN portion is disposed inside the mechanical enclosure.

Clause 24. The coupler of clause 22, wherein the SMF portion comprises an SMF proximal end and an SMF distal end, wherein the HCF portion comprises an HCF proximal end and an HCF distal end, and wherein the GRIN portion comprises a GRIN proximal end and a GRIN distal end.

Clause 25. The coupler of clause 24, wherein the GRIN proximal end touches the SMF distal end, and wherein the GRIN distal end touches the HCF proximal end.

Clause 26. The coupler of clause 25, wherein the GRIN proximal end is attached to the SMF distal end by fusion splicing or by using an adhesive, and wherein the GRIN distal end is attached to the HCF proximal end by fusion splicing or by using an adhesive.

Clause 27. The coupler of clause 24, wherein the SMF proximal end is configured to be connected to an SMF cable end and wherein the HCF distal end is configured to be connected to an HCF cable end.

Clause 28. The coupler of clause 27, wherein the SMF cable end is part of a data center.

Clause 29. The coupler of clause 22, wherein a length of the GRIN portion is based on at least one of: a mode field diameter of the SMF portion or the HCF portion, a numerical aperture of the HCF portion or the SMF portion, a physical diameter of the HCF portion or the SMF portion, or a diameter of the GRIN portion.

Clause 30. The coupler of clause 22, wherein a central axis of the GRIN portion is aligned with a central axis of the SMF portion.

Clause 31. The coupler of clause 22, wherein a central axis of the GRIN portion is disposed with an offset relative to a central axis of the SMF portion.

Clause 32. A coupler comprising: a mechanical enclosure; a single mode fiber (SMF) portion and a hollow core fiber (HCF) portion, wherein predefined parts or lengths of the SMF portion and the HCF portion are disposed inside the mechanical enclosure; and a graded index fiber (GRIN) portion and a low numerical aperture (NA) fiber portion disposed inside the mechanical enclosure, wherein: the GRIN portion is disposed between the SMF portion and the low NA fiber portion, and the low NA fiber portion is disposed between the GRIN portion and the HCF portion.

Clause 33. The coupler of clause 32, wherein a gap exists between the low NA fiber portion and the HCF portion.

Clause 34. The coupler of clause 32, wherein a GRIN proximal end is attached to an SMF distal end by fusion splicing or by using an adhesive.

Clause 35. The coupler of clause 32, wherein a GRIN distal end is attached to a low NA fiber proximal end by fusion splicing or by using an adhesive.

Clause 36. The coupler of clause 32, wherein a low NA fiber distal end is coated with an AR coating, and wherein the low NA fiber distal end faces the HCF portion.

Clause 37. The coupler of clause 32, wherein a low NA fiber distal end is etched using a motheye etching process, and wherein the low NA fiber distal end faces the HCF portion.

Clause 38. A coupler comprising: a hollow core fiber (HCF) portion; a single mode fiber (SMF) portion having an SMF proximal end and an SMF distal end, wherein the SMF distal end faces the HCF portion; and a metasurface added to the SMF distal end.

Clause 39. The coupler of clause 38, wherein a gap of a predefined non-zero length is present between the metasurface and the HCF portion.

Clause 40. The coupler of clause 39, further comprising a mechanical enclosure, wherein the metasurface, the gap, and predefined parts or lengths of the SMF portion and the HCF portion are disposed inside the mechanical enclosure.

Clause 41. The coupler of clause 39, wherein the gap is filled with air.

Clause 42. The coupler of clause 39, wherein the gap is filled with a predetermined gas.

Clause 43. A coupler comprising: a hollow core fiber (HCF) portion; a single mode fiber (SMF) portion having an SMF proximal end and an SMF distal end, wherein the SMF distal end faces the HCF portion; and a lens added to the SMF distal end.

Clause 44. The coupler of clause 43, wherein a gap of a predefined non-zero length is present between the lens and the HCF portion.

Clause 45. The coupler of clause 44, further comprising a mechanical enclosure, wherein the lens, the gap, and predefined parts or lengths of the SMF portion and the HCF portion are disposed inside the mechanical enclosure.

Clause 46. The coupler of clause 44, wherein the gap is filled with air.

Clause 47. The coupler of clause 44, wherein the gap is filled with a predetermined gas.

Clause 48. A coupler comprising: a hollow core fiber (HCF) portion having an HCF proximal end and an HCF distal end; and a lens or a metasurface added to the HCF proximal end.

Clause 49. A coupler comprising: a single mode fiber (SMF) portion; a hollow core fiber (HCF) portion, wherein a central axis of the SMF portion is disposed at a non-zero offset from a central axis of the HCF portion; and one or more reflective surfaces configured to enable an optical signal output from the SMF portion to enter the HCF portion or enable an optical signal output from the HCF portion to enter the SMF portion.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by +0.5%, +1%, +2%, +3%, +4%, +5%, +10%, +12%, or =15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 104 s, 103 s, 102 s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments in the present disclosure have been described in some detail for purposes of clarity of understanding, the invention is not limited to the details provided. There are many alternative ways of implementing the invention. The disclosed embodiments are illustrative and not restrictive.

What is claimed is:

1. A coupler comprising:
a single mode fiber (SMF) portion;
a hollow core fiber (HCF) portion; and
a graded index fiber (GRIN) portion disposed between the SMF portion and the HCF portion, wherein:
the GRIN portion comprises a GRIN proximal end and a GRIN distal end,
the GRIN proximal end touches the SMF portion, and
the GRIN distal end is engineered to reduce back-reflection.

2. The coupler of claim 1, wherein the GRIN distal end is engineered by etching a parabolic divot at the GRIN distal end.

3. The coupler of claim 2, wherein a profile or a curvature of the parabolic divot is based on a doping profile of the GRIN portion.

4. The coupler of claim 3, wherein the GRIN portion has a parabolic doping profile or distribution in which a dopant concentration is highest at a center portion of a cross-section of the GRIN portion.

5. The coupler of claim 3, wherein the doping profile of the GRIN portion is engineered or adjusted so that the profile or the curvature of the parabolic divot matches with an optimal curvature that focuses optical signals output from the SMF portion to a hollow core of the HCF portion.

6. The coupler of claim 1, wherein the GRIN distal end touches the HCF portion.

7. The coupler of claim 6, wherein the GRIN distal end is attached to the HCF portion by fusion splicing or by using an adhesive.

8. The coupler of claim 1, wherein a gap of a predefined non-zero length is present between the GRIN distal end and the HCF portion.

9. The coupler of claim 8, further comprising a mechanical enclosure, wherein the GRIN portion, the gap, and predefined parts or lengths of the SMF portion and the HCF portion are disposed inside the mechanical enclosure.

10. The coupler of claim 8, wherein the GRIN distal end is engineered by applying an anti-reflection (AR) coating to the GRIN distal end.

11. The coupler of claim 8, wherein the GRIN distal end is engineered by applying a dielectric coating to the GRIN distal end and etching the dielectric coating using a motheye etching process.

12. The coupler of claim 8, wherein the gap is filled with air or a predetermined gas.

13. A coupler comprising:
a single mode fiber (SMF) portion;
a hollow core fiber (HCF) portion;
a graded index fiber (GRIN) portion having a GRIN proximal end and a GRIN distal end, wherein the GRIN proximal end touches the SMF portion; and
a secondary fiber portion having a secondary fiber proximal end and a secondary fiber distal end, wherein the secondary fiber proximal end is attached to the GRIN distal end by fusion splicing or by using an adhesive, and wherein the secondary fiber distal end is engineered to reduce back-reflection.

14. The coupler of claim 13, wherein the secondary fiber portion is a low numerical aperture (NA) fiber portion.

15. The coupler of claim 13, wherein the secondary fiber portion is a coreless fiber portion.

16. The coupler of claim 13, wherein the secondary fiber distal end is engineered by applying an anti-reflection (AR) coating to the secondary fiber distal end.

17. The coupler of claim 13, wherein the secondary fiber distal end is engineered by etching the secondary fiber distal end using a motheye etching process.

18. The coupler of claim 13, wherein the secondary fiber distal end is attached to the HCF portion by fusion splicing or by using the adhesive.

19. The coupler of claim 13, wherein a gap of a predefined non-zero length is present between the secondary fiber distal end and the HCF portion.

20. The coupler of claim 19, further comprising a mechanical enclosure, wherein the GRIN portion, the secondary fiber portion, the gap, and predefined parts or lengths of the SMF portion and the HCF portion are disposed inside the mechanical enclosure.
